(19) United States
(12) Patent Application Publication
(10) Pub. No.: US 2017/0090608 A1
(43) Pub. Date: Mar. 30, 2017

(54) Proximity Sensor with Separate Near-Field and Far-Field Measurement Capability

(71) Applicant: Apple Inc., Cupertino, CA (US)

(72) Inventors: William Matthew Vieta, Santa Clara, CA (US); Alex Bijamov, Santa Clara, CA (US)

(21) Appl. No.: 15/273,540

(22) Filed: Sep. 22, 2016

Related U.S. Application Data
(60) Provisional application No. 62/235,149, filed on Sep. 30, 2015.

(51) Int. Cl. G06F 3/042; G06F 3/044; G06F 3/041

(52) U.S. Cl. CPC G06F 3/042; G06F 3/0416; G06F 3/044; G06F 2203/04108

(57) ABSTRACT

An electronic device that includes a proximity sensor may be provided. The proximity sensor may be a time-of-flight-based proximity sensor that is capable of separately outputting near-field measurements and far-field measurements. The near-field and far-field measurements may be placed in separate bins according to their time-of-flight values. The discrimination between near-field and far-field results may allow the electronic device to filter out false positive events where the presence of smudge or other surface contaminants can otherwise produce skewed readings and also to filter out false negative events where the presence of a user with dark hair or skin can otherwise produce misleading sensor results.

This application claims priority to U.S. provisional patent application No. 62/235,149, filed Sep. 30, 2015, which is hereby incorporated by reference herein in its entirety.

### BACKGROUND

This relates generally to electronic devices and, more particularly, to electronic devices with proximity sensors. Cellular telephones are sometimes provided with proximity sensors. For example, a cellular telephone may be provided with a proximity sensor that is located near an ear speaker on a front face of the cellular telephone.

The front face of the cellular telephone may also contain a touch screen display. The proximity sensor may be used to determine when the cellular telephone is near the head of a user. When not in proximity to the head of the user, the cellular telephone may be placed in a normal mode of operation in which the touch screen display is used to present visual information to the user and in which the touch sensor portion of the touch screen is enabled. In response to determining that the cellular telephone has been brought into the vicinity of the user's head, the display may be disabled to conserve power and the touch sensor on the display may be temporarily disabled to avoid inadvertent touch input from contact between the user's head and the touch sensor.

A proximity sensor for use in a cellular telephone may be based on an infrared light-emitting diode and a corresponding infrared light detector. During operation, the light-emitting diode may emit infrared light outwards from the front face of the cellular telephone. When the cellular telephone is not in the vicinity of a user's head, the infrared light will not be reflected towards the light detector and only small amounts of reflected light will be detected by the light detector. When, however, the cellular telephone is adjacent to the user's head, the emitted light from the infrared light-emitting diode will be reflected from the user's head and detected by the light detector.

Light-based proximity sensors such as these may be used to detect the position of a cellular telephone relative to a user's head but can be challenging to operate accurately. If care is not taken, it can be difficult to determine when a user's head is in the vicinity of the cellular telephone, particularly when a user has hair that is dark and exhibits low reflectivity or when the proximity sensor has become smudged with grease from the skin of the user.

It is within this context that the embodiments herein arise.

### SUMMARY

An electronic device may be provided with electronic components such as a touch screen display. The touch screen display may be controlled based on information from a proximity sensor. For example, when the proximity sensor indicates that the electronic device is not near the head of a user, the electronic device may be operated in a normal mode in which the display is used to display images and in which the touch sensor functionality of the display is enabled. When the proximity sensor indicates that the electronic device is in the vicinity of the user's head, the electronic device may be operated in a close proximity mode in which display pixels in the display are disabled and in which the touch sensor functionality of the display is disabled.

In accordance with an embodiment, the proximity sensor may be configured to provide near-field measurement results and far-field measurement results. The electronic device may also include processing circuitry that receives the near-field measurement results and the far-field measurement results from the proximity sensor. The processing circuitry selectively enables and disables the touch screen display based on the received near-field measurement results and the far-field measurement results. The near-field measurement results may include a first distance value and a first intensity value, whereas the far-field measurement results include a second distance value and a second intensity value.

The near-field measurement results and the far-field measurement results may be grouped into separate bins so that the near-field measurement results capture information relating to objects located within a predetermined distance from an external surface of the display and so that the far-field measurement results capture information relating to objects located beyond the predetermined distance from the external surface of the display. In general, the electronic device will be configured in close proximity mode by disabling the touch screen display in response to determining that an external object is being brought into close proximity with the electronic device and will be configured in normal mode by enabling the touch screen display in response to determining that an external object is being moved away from the electronic device.

In some embodiments, the processing circuitry may be configured to filter out or ignore the near-field measurement results. For example, the processing circuitry monitors the near-field measurement results to determine when dark objects make physical contact with the display or to determine when smudge is deposited on the display. The processing circuitry may also be configured to detect for sudden changes in the far-field measurement results and/or the near-field measurement results. Operating the electronic and proximity sensor in this way can help minimize the occurrence of false positive events due to smudge and other surface-type contaminants and the occurrence of false negative events due to objects with poor reflectivity.

Further features of the present invention, its nature and various advantages will be more apparent from the accompanying drawings and the following detailed description.

### BRIEF DESCRIPTION OF THE DRAWINGS

FIG. 1 is a perspective view of an illustrative electronic device with a proximity sensor in accordance an embodiment.

FIG. 2 is a schematic diagram of an illustrative electronic device with a proximity sensor in accordance with an embodiment.

FIG. 3 is a graph showing how an electronic device may adjust display and touch sensor functionality in response to proximity sensor measurements in accordance with an embodiment.

FIG. 4 is cross-sectional side view of an illustrative electronic device having a display layer and a proximity sensor in accordance with an embodiment.

FIG. 5 is a diagram illustrating how smudge can affect the accuracy of the proximity sensor in accordance with an embodiment.

FIG. 6A is a diagram showing an output of a conventional intensity-based proximity sensor.

FIG. 6B is a diagram showing an output of a conventional time-of-flight (ToF) proximity sensor.

FIG. 6C is a diagram showing how near-field effects can affect the accuracy of a conventional time-of-flight proximity sensor.

FIG. 7 is a diagram of an illustrative ToF-based proximity sensor that is capable of outputting a near-field sensor reading and a separate far-field sensor reading in accordance with an embodiment.

FIG. 8 is a diagram showing the separation of near-field and far-field measurements of an improved time-of-flight proximity sensor in accordance with an embodiment.

FIG. 9 is a diagram showing how near-field and far-field measurements can be grouped into separate bins in accordance with an embodiment.

FIG. 10 is a timing diagram illustrating a normal use case scenario in which a proximity sensor senses an approaching object in accordance with an embodiment.

FIG. 11 is a timing diagram illustrating another use case scenario in which a proximity sensor detects touchdown and liftoff events for poor reflectors in accordance with an embodiment.

FIG. 12 is a flow chart of illustrative steps for operating a proximity sensor of the type described in connection with the embodiments of FIGS. 7-11.

### DETAILED DESCRIPTION

An electronic device may be provided with electronic components such as touch screen displays. The functionality of the electronic device may be controlled based on how far the electronic device is located from external objects such as a user's head. When the electronic device is not in the vicinity of the user's head, for example, the electronic device can be operated in a normal mode in which the touch screen display is enabled. In response to detection of the presence if the user's head in the vicinity of the electronic device, the electronic device may be operated in a mode in which the touch screen is disabled or other appropriate actions are taken.

Disabling touch sensing capabilities from the electronic device when the electronic device is near the user's head may help avoid inadvertent touch input as the touch sensor comes into contact with the user's ear and hair. Disabling display functions in the touch screen display when the electronic device is near the user's head may also help conserve power and reduce user confusion about the status of the display.

An electronic device may use one or more proximity sensors to detect external objects. As an example, an electronic device may use an infrared-light-based proximity sensor to gather proximity data. During operation, proximity data from the proximity sensor may be compared to one or more threshold values. Based on this proximity sensor data analysis, the electronic device can determine whether or not the electronic device is near the user's head and can take appropriate action. A proximity sensor may detect the presence of external objects via optical sensing mechanisms, electrical sensing mechanism, and/or other types of sensing techniques.

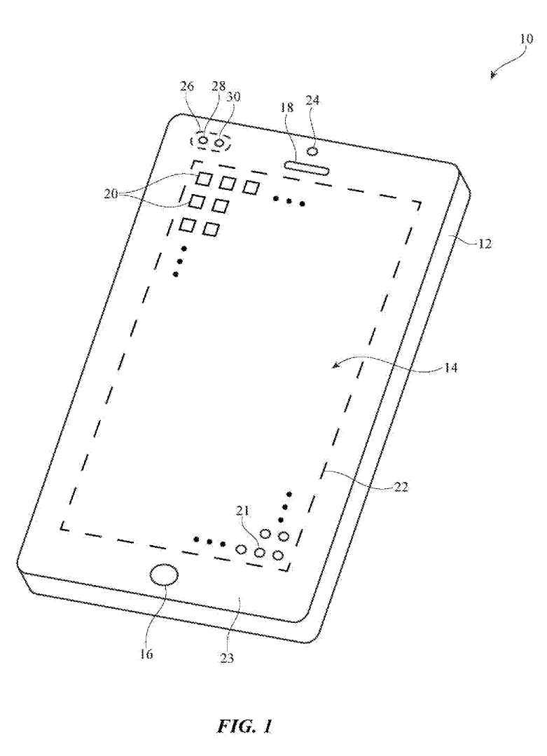

An illustrative electronic device that may be provided with a proximity sensor is shown in FIG. 1. Electronic devices such as device 10 of FIG. 1 may be cellular telephones, media players, other handheld portable devices, somewhat smaller portable devices such as wrist-watch devices, pendant devices, or other wearable or miniature devices, gaming equipment, tablet computers, notebook computers, desktop computers, televisions, computer monitors, computers integrated into computer displays, or other electronic equipment.

As shown in the example of FIG. 1, device 10 may include a display such as display 14. Display 14 may be mounted in a housing such as housing 12. Housing 12 may have upper and lower portions joined by a hinge (e.g., in a laptop computer) or may form a structure without a hinge, as shown in FIG. 1. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.).

Display 14 may be a touch screen display that incorporates a layer of conductive capacitive touch sensor electrodes such as electrodes 20 or other touch sensor components (e.g., resistive touch sensor components, acoustic touch sensor components, force-based touch sensor components, light-based touch sensor components, etc.) or may be a display that is not touch-sensitive. Capacitive touch screen electrodes 20 may be formed from an array of indium tin oxide pads or other transparent conductive structures.

Display 14 may include an array of display pixels such as pixels 21 formed from liquid crystal display (LCD) components, an array of electrophoretic display pixels, an array of plasma display pixels, an array of organic light-emitting diode display pixels, an array of electrowetting display pixels, or display pixels based on other display technologies. The brightness of display 14 may be adjustable. For example, display 14 may include a backlight unit formed from a light source such as a lamp or light-emitting diodes that can be used to increase or decrease display backlight levels (e.g., to increase or decrease the brightness of the image produced by display pixels 21) and thereby adjust display brightness. Display 14 may also include organic light-emitting diode pixels or other pixels with adjustable intensities. In this type of display, display brightness can be adjusted by adjusting the intensities of drive signals used to control individual display pixels.

Display 14 may be protected using a display cover layer such as a layer of transparent glass or clear plastic. Openings may be formed in the display cover layer. For example, an opening may be formed in the display cover layer to accommodate a button such as button 16. An opening may also be formed in the display cover layer to accommodate ports such as speaker port 18.

In the center of display 14 (e.g., in the portion of display 14 within rectangular region 22 of FIG. 1), display 14 may contain an array of active display pixels such as pixels 21. Region 22 may therefore sometimes be referred to as the active region of display 14. The rectangular ring-shaped region 23 that surrounds the periphery of active display region 22 may not contain any active display pixels and may therefore sometimes be referred to as the inactive region of display 14. The display cover layer or other display layers in display 14 may be provided with an opaque masking layer in the inactive region to hide internal components from view by a user. Openings may be formed in the opaque masking layer to accommodate light-based components. For example, an opening may be provided in the opaque masking layer to accommodate an ambient light sensor such as ambient light sensor 24.

If desired, an opening in the opaque masking layer may be filled with an ink or other material that is transparent to infrared light but opaque to visible light. As an example, light-based proximity sensor 26 may be mounted under this type of opening in the opaque masking layer of the inactive portion of display 14. Light-based proximity sensor 26 may include a light transmitter such as light source 28 and a light sensor such as light detector 30. Light source 28 may be an infrared light-emitting diode and light detector 30 may be a photodetector based on a transistor or photodiode (as examples). During operation, proximity sensor detector 30 may gather light from source 28 that has reflected from nearby objects. Other types of proximity sensor may be used in device 10 if desired. The use of a proximity sensor that includes infrared light transmitters and sensors is merely illustrative.

Proximity sensor 26 may detect when a user's head, a user's fingers, or other external object is in the vicinity of device 10 (e.g., within 10 cm of less of sensor 26, within 5 cm or less of sensor 26, within 1 cm or less of sensor 26, or within other suitable distance of sensor 26).

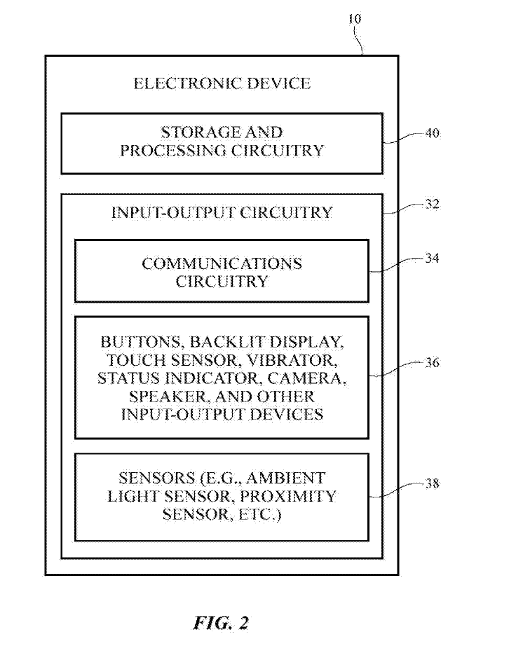

A schematic diagram of device 10 showing how device 10 may include sensors and other components is shown in FIG. 2. As shown in FIG. 2, electronic device 10 may include control circuitry such as storage and processing circuitry 40. Storage and processing circuitry 40 may include one or more different types of storage such as hard disk drive storage, nonvolatile memory (e.g., flash memory or other electrically-programmable-read-only memory), volatile memory (e.g., static or dynamic random-access-memory), etc. Processing circuitry in storage and processing circuitry 40 may be used in controlling the operation of device 10. The processing circuitry may be based on a processor such as a microprocessor and other suitable integrated circuits. With one suitable arrangement, storage and processing circuitry 40 may be used to run software on device 10, such as internet browsing applications, email applications, media playback applications, operating system functions, software for capturing and processing images, software implementing functions associated with gathering and processing sensor data, software that makes adjustments to display brightness and touch sensor functionality, etc.

Input-output circuitry 32 may be used to allow data to be supplied to device 10 and to allow data to be provided from device 10 to external devices. Input-output circuitry 32 may include wired and wireless communications circuitry 34. Communications circuitry 34 may include radio-frequency (RF) transceiver circuitry formed from one or more integrated circuits, power amplifier circuitry, low-noise input amplifiers, passive RF components, one or more antennas, and other circuitry for handling RF wireless signals. Wireless signals can also be sent using light (e.g., using infrared communications).

Input-output circuitry 32 may include input-output devices 36 such as button 16 of FIG. 1, joysticks, click wheels, scrolling wheels, a touch screen such as display 14 of FIG. 1, other touch sensors such as track pads or touch-sensor-based buttons, vibrators, audio components such as microphones and speakers, image capture devices such as a camera module having an image sensor and a corresponding lens system, keyboards, status-indicator lights, tone generators, key pads, and other equipment for gathering input from a user or other external source and/or generating output for a user.

Sensor circuitry such as sensors 38 of FIG. 2 may include an ambient light sensor for gathering information on ambient light levels such as ambient light sensor 24. Sensors 38 may also include proximity sensor components. Sensors 38 may, for example, include a dedicated proximity sensor such as proximity sensor 26 and/or a proximity sensor formed from touch sensors 20 (e.g., a portion of the capacitive touch sensor electrodes in a touch sensor array for display 14 that are otherwise used in gathering touch input for device 10 such as the sensor electrodes in region 22 of FIG. 1). Proximity sensor components in device 10 may, in general, include capacitive proximity sensor components, infrared-light-based proximity sensor components, proximity sensor components based on acoustic signaling schemes, or other proximity sensor equipment. Sensors 38 may also include a pressure sensor, a temperature sensor, an accelerometer, a gyroscope, and other circuitry for making measurements of the environment surrounding device 10.

Sensor data such as proximity sensor data from sensors 38 may be used in controlling the operation of device 10. Device 10 can activate or inactivate display 14, may activate or inactivate touch screen functionality, may activate or inactivate a voice recognition function on device 10, or may take other suitable actions based at least partly on proximity sensor data.

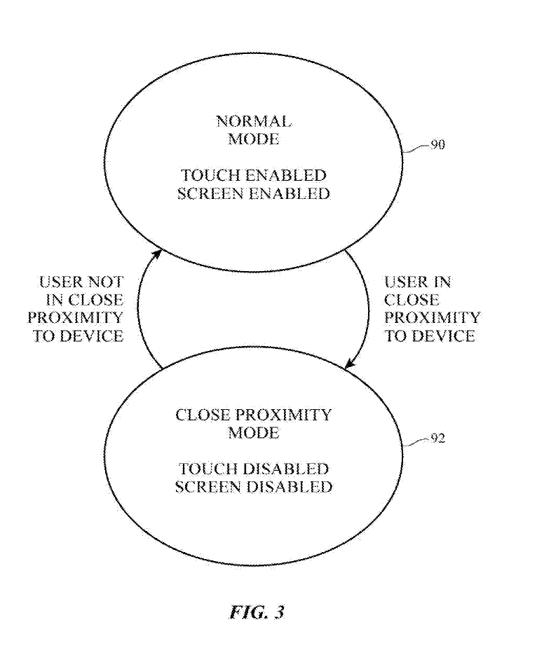

FIG. 3 is a diagram illustrating how the operation of device 10 may be controlled using proximity sensor data from proximity sensor 26. In state 90, device 10 may be operated in a normal mode. For example, device 10 may be operated in a mode in which storage and processing circuitry 40 enables touch sensor operation (e.g., the operation of touch sensor electrodes 20 for touch screen display 14) and enables display 14 (e.g., by adjusting display pixels 21 so that an image is displayed for a user). During the normal mode operations of step 76, device 10 may use control circuitry 40 to gather and analyze proximity sensor data from proximity sensor 26.

When the proximity sensor data is indicative of a user in close proximity to device 10, device 10 may be operated in a close proximity mode (i.e., state 92). In state 92, device 10 can take actions that are appropriate for scenarios in which device 10 is held adjacent to the head of the user. For example, control circuitry 40 may temporarily disable touch screen functionality in display 14 and/or may disable display 14 (e.g., by turning off display pixel array 21). While operating in state 92, device 10 may use control circuitry 40 to gather and analyze proximity sensor data from proximity sensor 26 to determine whether the user is no longer in close proximity to device 10. When the proximity sensor data is indicative of the absence of a user in close proximity to device 10, device 10 may be placed back into state 90.

The example of FIG. 3 is merely illustrative. Device 10 may, in general, take any suitable action based on proximity sensor data. For example, device 10 may activate or inactivate voice recognition capabilities for device 10, may invoke one or more software programs, may activate or inactivate operating system functions, or may otherwise control the operation of device 10 in response to proximity sensor information.

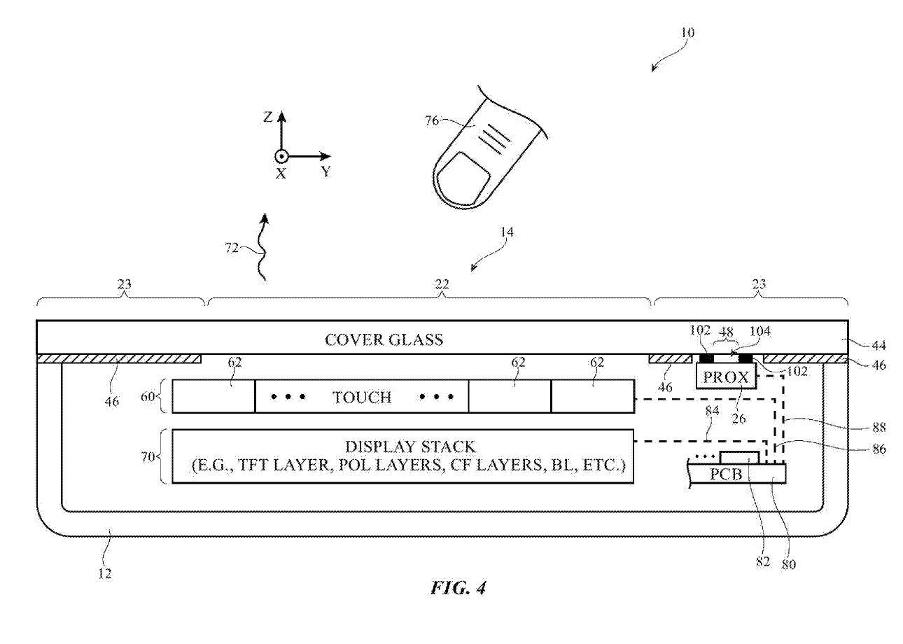

FIG. 4 is a cross-sectional side view of device 10. As shown in FIG. 4, device 10 may include a display such as display 14. Display 14 may have a cover layer such as cover layer 44. Cover layer 44 may be formed from a layer of glass, a layer of plastic, or other transparent material. If desired, the functions of cover layer 44 may be performed by other display layers (e.g., polarizer layers, anti-scratch films, color filter layers, etc.). The arrangement of FIG. 3 is merely illustrative.

Display structures that are used in forming images for display 14 may be mounted under active region 22 of display 14. Display 14 may include a display stack structure 70 having a backlight unit, light polarizing layers, color filter layers, thin-film transistor (TFT) layers, and other display structures. Display 14 may be implemented using liquid crystal display structures. If desired, display 14 may be implemented using other display technologies. The use of a liquid crystal display is merely illustrative.

The display structures of display 14 may include a touch sensor array such as touch sensor array 60 for providing display 14 with the ability to sense input from an external object such as external object 76 when external object 76 is in the vicinity of a touch sensor on array 60. With one suitable arrangement, touch sensor array 60 may be implemented on a clear dielectric substrate such as a layer of glass or plastic and may include an array of indium tin oxide electrodes or other clear electrodes such as electrodes 62. The electrodes may be used in making capacitive touch sensor measurements.

An opaque masking layer such as opaque masking layer 46 may be provided in inactive region 26. The opaque masking layer may be used to block internal device components from view by a user through peripheral edge portions of clear display cover layer (sometimes referred to as cover glass) 44. The opaque masking layer may be formed from black ink, black plastic, plastic or ink of other colors, metal, or other opaque substances. Windows such as proximity sensor window 48 may be formed in opaque masking layer 46. For example, circular holes or openings with other shapes may be formed in layer 46 to serve as proximity sensor window 48.

At least one proximity sensor 26 may be provided in device 10. As shown in FIG. 4, proximity sensor 26 may be mounted within device 10 by attaching proximity sensor 26 directly to the inner surface of cover glass 44 at proximity sensor window 48 via pressure sensitive adhesive 102 or other adhesive materials. Space 104 between proximity sensor 26 and cover glass 44 may be filled with air, glass, plastic, or other transparent material so that light may pass through window 48 during optical proximity sensing operations. If desired, proximity sensor 26 may be mounted to opaque masking layer 46, on other layers of display 14, printed circuit boards, housing structures, or other suitable mounting structures within housing 12 of device 10.

Display, touch, and sensor circuitry in device 10 may be coupled to circuitry on a substrate such as printed circuit board (PCB) 80. The circuitry on substrate 80 may include integrated circuits and other components (e.g., storage and processing circuitry 30 of FIG. 2). For example, circuitry in display stack 70 may be coupled to circuitry on substrate 80 via path 84, circuitry in touch sensor array 60 may be coupled to circuitry on substrate 80 via path 86, and proximity sensor 26 may be coupled to circuitry on substrate 80 via path 88. Paths 84, 86, and 88 may be formed using flexible printed circuit (“flex circuit”) cables, indium tin oxide traces or other conductive patterned traces formed on a dielectric substrate, and/or other conductive signal path structures.

During operation of device 10, optical sensor signals may pass through proximity sensor window 48 for use in detecting the proximity of a user body part. Signals from proximity sensor 26 may be routed to analog-to-digital converter circuitry that is implemented within the silicon substrates from which proximity sensor 26 is formed, to analog-to-digital converter circuitry that is formed in an integrated circuit that is mounted to display stack 70, or to analog-to-digital converter circuitry and/or other control circuitry located elsewhere in device 10 such as one or more integrated circuits in storage and processing circuitry 30 of FIG. 2 (e.g., integrated circuits containing analog-to-digital converter circuitry for digitizing analog proximity sensor signals from sensor 26 such as integrated circuits 82 on substrate 80).

If desired, a proximity sensor may be implemented as part of a silicon device that has additional circuitry (i.e., proximity sensor 26 may be implemented as integrated circuits). A proximity sensor with this type of configuration may be provided with built-in analog-to-digital converter circuitry and communications circuitry so that digital sensor signals can be routed to a processor using a serial interface or other digital communications path.

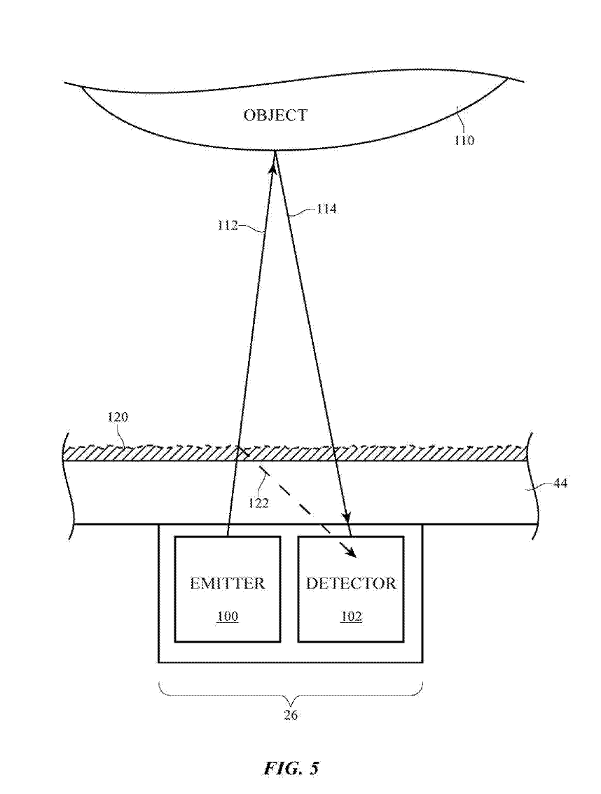

FIG. 5 is a diagram illustrating certain issues that may arise during operation of a proximity sensor. As shown in FIG. 5, proximity sensor 26 may include an emitter element 100 and a detector element 102 that are used to perform optical proximity sensing operations. Emitter 100 and detector 102 may, for example, be formed on the same integrated circuit or on separate integrated circuits within one integrated circuit package.

During operation, emitter 100 may emit light 112 outwards from the front face of device 10. When device 10 is not in the vicinity of a user's head, the infrared light will not be reflected towards detector 102 and only small amounts of reflected light will be detected by detector 102. When, however, device 10 is adjacent to the user's head or other nearby object 110, emitted light 112 will be reflected from nearby object 110 and detected by sensor 112 (see, e.g., reflected light 114).

In the exemplary scenario as illustrated in FIG. 5, a layer of contaminants 120 (e.g., smudge from finger grease, facial oil, or other contaminants) may be temporarily deposited on cover glass 44 above proximity sensor 26. When smudge 120 is present over proximity sensor 26, more infrared light will be reflected into light detector 102 than expected (e.g., a portion of light 112 may be inadvertently reflected back towards detector 102 in the presence of smudge, as indicated by dispersion path 122) and may potentially result in a false positive reading. In other scenarios, object 110 such as a user with dark hair that is in fact approaching proximity sensor 26 may exhibit poor reflectivity. In such scenarios, detector 102 may not be able to correctly sense the presence of that object, which would potentially result in a false negative reading.

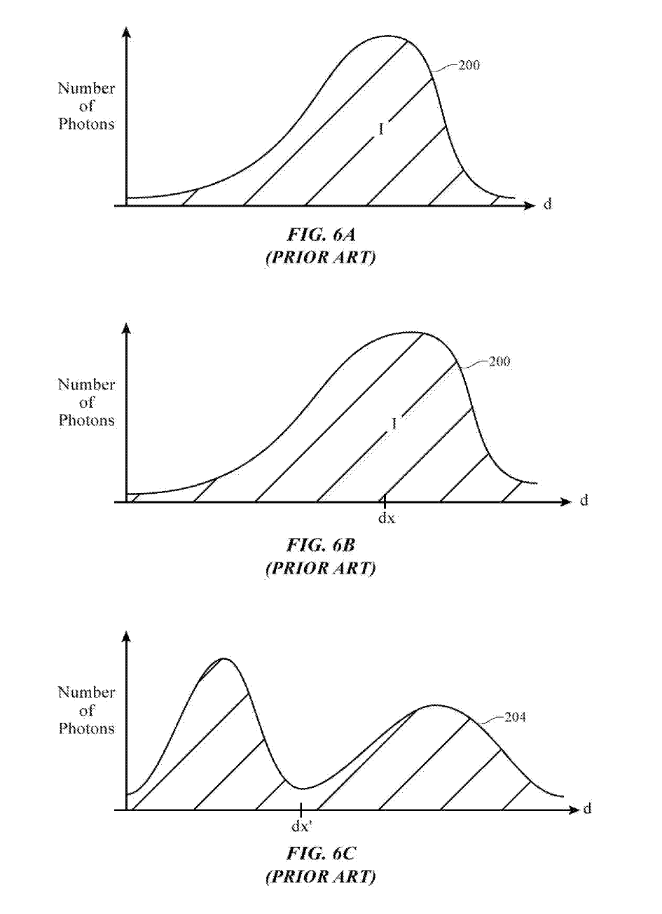

FIG. 6A is a diagram showing an output of a conventional intensity-based proximity sensor. In particular, FIG. 6A illustrates an exemplary curve 200 that plots the number of received photons as a function of distance from the proximity sensor. A conventional intensity-based proximity sensor would only be able to produce a cumulative light intensity reading I that reflects the total integral under curve 200. Since this type of sensor does not provide any distance information, its main drawback is that it cannot separate out competing near-field effects such as smudge/smear on the cover glass versus dark hair on the cover glass.

In an effort to overcome this constraint, time-of-flight (ToF) proximity sensors have been developed that output distance information in addition to the intensity output. FIG. 6B is a diagram showing an output of a conventional ToF-based proximity sensor that may be implemented using a vertical-cavity surface-emitting laser (VCSEL) emitter and detector, as an example. If desired, other types of ToF-based proximity sensors may also be used. As shown in FIG. 6B, a conventional ToF-based proximity sensor may be able to produce an effective distance reading dx in addition to the cumulative light intensity reading I. Distance reading dx is essentially an intensity-weighted average of the overall sensor reading. For example, output dx may be computed based on a weighted histogram of distance values. However, this additional piece of information does not really help when both near-field components and far-field components are present, as illustrated in the scenario of FIG. 6C.

FIG. 6C is a diagram showing how near-field effects can affect the accuracy of a conventional time-of-flight proximity sensor. As shown in FIG. 6C, curve 204 may exhibit a first hump representing near-field effects (e.g., effects due to the presence of smudge, smear, and/or other contaminants) and a second hump representing far-field effects such as the presence of a user operating the electronic device. In this scenario, the effective distance reading dx′ does not really provide a good indication of what is actually happening since the histogram would be substantially skewed towards the first hump. The presence of near-field effects would therefore result in an intensity-weighted distance error, which can negatively affect the accuracy of the proximity sensor.

Moreover, neither the intensity reading nor the distance reading output by this type of sensor will be able to accurately detect for the presence of objects with poor reflectivity. It would therefore be desirable to provide improved proximity sensor circuitry that minimizes the chance of false positive and false negative readings.

Conventional proximity sensors only utilize infrared light emission and infrared light detection to sense the proximity of a user's hair, ear, or other body part. The hair of users varies in reflectivity in the infrared light spectrum. Dark (e.g., black) hair tends to absorb infrared light, rather than reflecting infrared light. Dark hair may, for example, reflect less infrared light than skin. As a result, relatively low magnitude infrared-light reflections may be measured when a dark-haired (e.g., black-haired) user places device 10 next to the user's head to make a telephone call. Smudges from finger grease or other contaminants also have the potential to affect proximity sensor readings. When a smudge is present over the proximity sensor, more infrared light will be reflected into light detector 30 than expected.

During operation, care must be taken to avoid false negatives (e.g., situations in which the absorption of light by dark hair makes it erroneously appear as though device 10 is not in the vicinity of the user's head when it is) and false positives (e.g., situations in which the reflection of light from a smudge makes it erroneously appear as though device 10 is in the vicinity of the user's head when it is not).

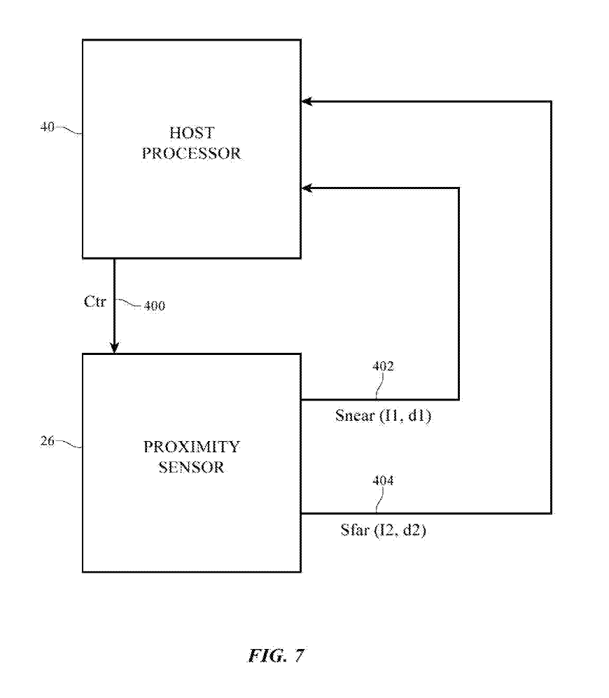

FIG. 7 is a diagram of an illustrative ToF-based proximity sensor 26 that is capable of outputting a near-field sensor reading and a separate far-field sensor reading in accordance with an embodiment of the present invention. Proximity sensor 26 configured as such is able to filter out false negatives and false positives, as will be apparent from the follow description. As shown in FIG. 7, proximity sensor 26 may generate a first sensor output Snear that is indicative of near-field measurements and a second sensor output Sfar that is indicative of far-field measurements. Sensor output Snear may include both intensity information I1 and distance information d1 for objects sensed within a predetermined distance from the cover glass (e.g., for detecting objects within 10 cm of the cover glass, within 5 cm of the cover glass, within 3 cm of the cover glass, within 1 cm of the cover glass, or even objects directly on the cover glass). On the other hand, sensor output Sfar may likewise include both intensity information I2 and distance information d2 for objects sensed greater than a predetermined distance from the cover glass (e.g., for detecting objects beyond the near-field sensing region).

Proximity sensor 26 may provide outputs Snear and Sfar to host processor 40 (e.g., the storage and processing circuitry described in FIG. 2) via paths 402 and 404, respectively. Processor 40 may analyze the received measurements and take appropriate action on the electronic device (e.g., to adjust the display brightness, to disable the touch sensor functionality, to enable the ear speaker, etc.). If desired, host processor 40 may provide control signals Ctr to proximity sensor via path 400 that can be used to adjust the threshold delineating the border between the near-field and far-field measurements. By allowing dynamic tunability of this threshold, the electronic device may be configured to detect different types of near-field effects.

For example, some near-field effects such as smudge or grease are deposited directly on the cover glass and tend to be very close to the sensor, whereas other near-field effects such as a user's dark hair held close to the surface of the cover may be relatively farther. Having flexibility in adjusting the near-field versus far-field border enables the device to selectively filter out potentially problematic events. By moving the threshold closer to the exterior surface of the cover glass, the sensor would be better able to focus on the presence of contaminants disposed directly on the cover glass, whereas moving the threshold further way from the surface might allow the sensor to better sense objects that are merely held close to but not on the surface of the cover glass.

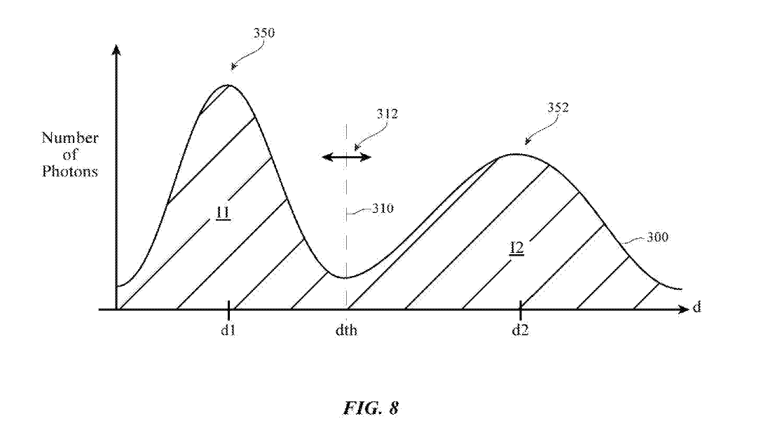

FIG. 8 is a diagram showing the separation of near-field and far-field measurements of improved time-of-flight (ToF) proximity sensor 26 of FIG. 7. Curve 300 represents an intensity weighted histogram of distance values that can be gathered using the proximity sensor. As shown in FIG. 8, measurements to the left of threshold dth (marked as dotted line 310) may be captured in the form of near-field intensity reading I1 and distance reading d1, whereas measurements to the right of line 310 may be captured in the form of far-field sensor intensity reading I2 and distance reading d2. This ability to discriminate between the near-field effects (see, e.g., first hump 350 within the near-field region) and the far-field effects (see, second hump 352 in the far-field region) allows the proximity sensor to simultaneously analyze the separate readings and to more accurately filter out false positives and false negatives.

For example, the false positive issues associated with smudge and other surface residues can be resolved by simply filtering out or ignoring the near-field readings. In such scenarios, it may be desirable to adjust threshold dth as close to the surface of the cover glass as possible, as indicated by arrows 312. As another example, false negative issues associated with objects of poor reflectivity (e.g., a user with dark hair) can be resolved by closely monitoring the near-field readings to detect for sudden jumps in I1 or d1. In such scenarios, it may be desirable to adjust threshold dth to be slightly above the surface of the cover glass to allow extra margin in the event that the user does not physically press the device to his head. In general, threshold dth may be optimally selected via a cost function analysis to collectively minimize the probability of false positive and false negative events.

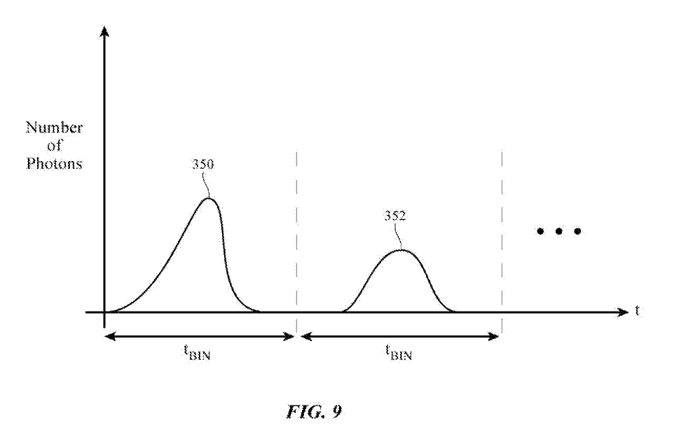

FIG. 9 is a diagram showing how near-field and far-field measurements can be grouped into separate bins. As shown in FIG. 9, photons 350 detected within a first period of time may be accumulated in a first bin; photons 352 detected within a second period of time follow the first period of time may be accumulated in a second bin; and so on. The grouping of bins may be implemented using a phase-locked loop (PPL) circuit that generates multiple clock signals having identical frequencies but are phase-offset with respect to one another. The clock signals with different phases may, as an example, be combined via exclusive-OR (XOR) gating circuitry to selectively gate the accumulation of photons within the respective bins. This particular binning implementation is merely illustrative. In general, the proximity sensor measurements may be grouped into a “near” bin, a “far” bin, and/or one or more intermediate bins based on the time-of-flight value.

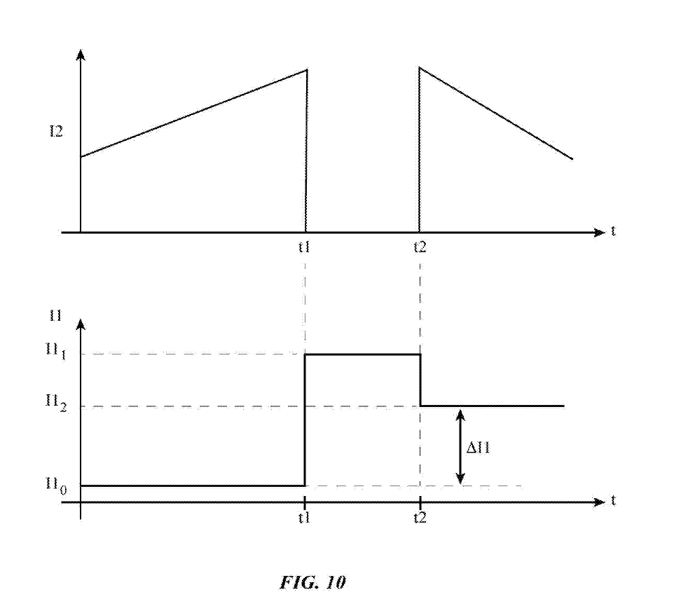

FIG. 10 is a timing diagram illustrating a normal use case scenario in which proximity sensor 26 detects a strong far-field presence. Prior to time t1, the far-field intensity reading I2 may be substantial and may be monotonically increasing to signify that an object with normal reflectivity is being brought towards the electronic device. The corresponding far-field distance reading d2 (not shown in FIG. 10) may be monitored to determine when the device should be switched from normal mode to close proximity mode (FIG. 3). Meanwhile, the near-field intensity reading I1 may be low (at I1₀), indicating an absence of surface residues within the near-field range.

At time t1, far-field intensity reading I2 instantaneously drops low, thereby indicating that the external object has at least entered the near-field region, potentially making physical contact with the surface of the cover glass to completely block the proximity sensor's field of view. Meanwhile, near-field intensity reading I1 instantaneously rises high to I1₁ at time t1, thereby indicating the presence of the external object within the near-field range.

The duration of time from time t1 to time t2 may be equal to the amount of time that the device is held in close proximity with the external object. At time t2, the object may be moved away from the proximity sensor. As a result, far-field intensity reading I2 jumps back to its previous high value but monotonically decreases. Meanwhile, near-field intensity reading I1 drops to a lower value at time t2. In this particular scenario, reading I1 does not drop back down to the original value I1₀ but rather to an intermediate level I1₂, which is ΔI1 greater than I1₀. This gain ΔI1 in the baseline near-field intensity reading may be due to smudge, grease, oil, or other residue left from the user's skin or hair during the period of contact between time t1 and t2. Configuring proximity sensor 26 to separately monitor I1 and I2 in this way can therefore be an effective way of baselining near-field effects such as smudge during normal use case scenarios.

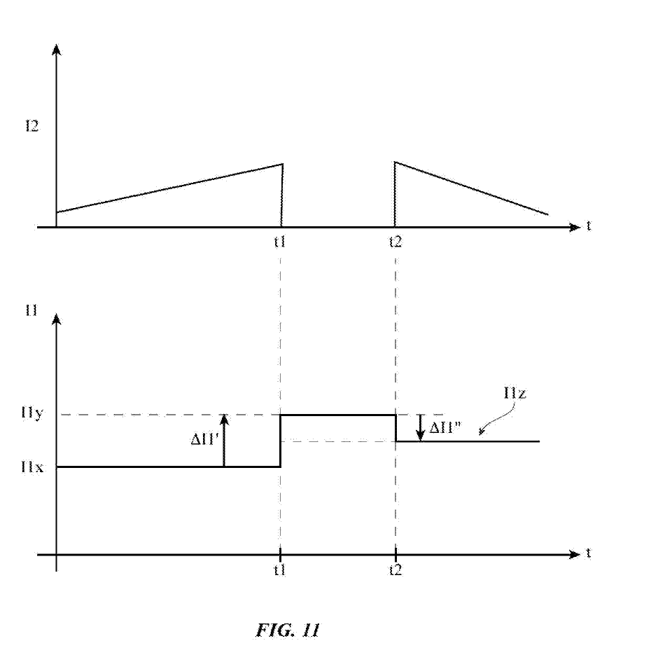

FIG. 11 is a timing diagram illustrating another use case scenario in which a proximity sensor detects touchdown and liftoff events for poor reflectors such as a user with dark hair or skin. Prior to time t1, the far-field intensity reading I2 may be low (due to the poor reflectivity of the external object) but may nevertheless be monotonically increasing to signify that an object with poor reflectivity is being brought towards the electronic device. As described above, the corresponding far-field distance reading d2 may be monitored, but in this instance, the signal may be too weak to accurately determine when the device should be switched from normal mode to close proximity mode. Meanwhile, the near-field intensity reading I1 may be relatively high at I1_{X}, indicating the presence of surface residues within the near-field range.

At time t1, far-field intensity reading I2 instantaneously drops low, thereby indicating that the external object has at least entered the near-field region, potentially making physical contact with the surface of the cover glass to completely block the proximity sensor's field of view. Meanwhile, near-field intensity reading I1 instantaneously rises high to I1_{Y} at time t1, thereby indicating the presence of the external object within the near-field range. Note that the rise of ΔI1′ is relatively small but may be nevertheless be sufficient to signify detection of a touchdown event for a poor reflector.

The duration of time from time t1 to time t2 may be equal to the amount of time that the device is held in close proximity with the external object. At time t2, the object may be moved away from the proximity sensor. As a result, far-field intensity reading I2 jumps back to its previous value but monotonically decreases with time. Meanwhile, near-field intensity reading I1 drops to a lower value at time t2. Similar to the scenario in FIG. 10, reading I1 may not drop back down to the original value I1_{X} but rather to an intermediate level I1_{Z}, which is only ΔI1″ less than I1_{Y}. If ΔI1″ is less than ΔI1′, then it can be determined that additional smudge, grease, oil, or other residue was left over from the user's skin or hair during the period of contact between time t1 and t2. Note that the change of ΔI1″ may be relatively small but may nevertheless be adequate to signify detection of a liftoff event for a poor reflector. Configuring proximity sensor 26 with the ability to isolate near-field sensor reading I1 from I2 in this way can therefore be an effective way of discriminating between liftoff and touchdown events for objects with poor reflectivity even when a strong near-field signal is present.

In yet other suitable embodiments, the proximity sensor can provide an estimate of the object's reflectivity be removing any influence of near-field distance information. By ignoring the near-field signals I1 and d1 and only focusing on the far-field readings I2 and d2, the proximity sensor may simply look for jumps in I2 without regard to any near-field effects. For example, an instantaneous drop in I2 would signify a touchdown event for an object with arbitrary reflectivity, whereas an instantaneous rise in I2 would signify a liftoff even for that object. Operating the proximity sensor in this way may be advantageous since it only needs to monitoring one set of signals instead of having to analyze both near-field and far-field signal components simultaneously.

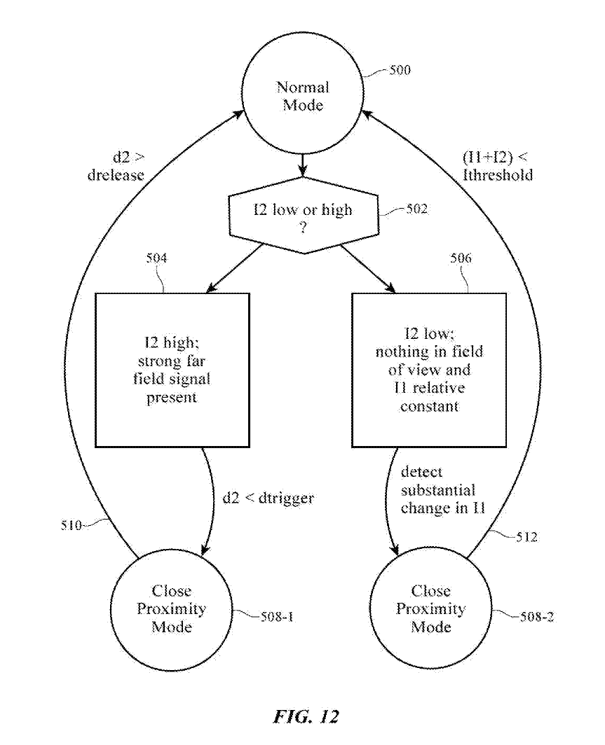

FIG. 12 is a flow chart of illustrative steps for operating an electronic device having a proximity sensor of the type described in connection with the embodiments of FIGS. 7-11. At step 500, electronic device 10 may be configured in normal mode (e.g., a normal mode in which the touch sensor operation and the display function of device 10 is enabled).

At step 502, far-field intensity reading I2 may be compared to a predetermined threshold to determine whether I2 is “high” (to indicate a strong far-field presence) or “low” (to indicate that nothing is detected in the sensor's far-field of view. The lack of far-field presence could also potentially be due to an object's poor reflectivity (e.g., from a user's black hair or skin).

Processing may proceed to state 504 if far-field intensity reading I2 is high. At this point, proximity sensor 26 may monitor the far-field distance reading d2 to determine whether d2 has fallen below a trigger threshold value dtrigger. In response to signal d2 falling below threshold value dtrigger, device 10 may be placed in close proximity mode 508-1. As described in connection with FIG. 3, device 10 may temporarily disable touch screen functionality in display 14 and/or may disable display 14 when operated in mode 508-1.

Device 10 may continue operating in mode 508-1 until signal d2 exceeds a release threshold value drelease. In response to signal d2 exceeding value drelease, device 10 may return to normal mode 500, as indicated by path 510. If desired, threshold values dtrigger and drelease may be equal or may be different. In certain embodiments, threshold value dtrigger may actually be less than threshold value drelease to provide a hysteresis mechanism so that inadvertent switching between modes 500 and 508-1 when reading I2 is high would be minimized.

Processing may proceed from step 502 to state 506 if far-field intensity reading I2 is low. In general, near-field intensity reading I1 should be relatively constant in the absence of an external object repeatedly touching the surface of the cover glass of device 10. However, when proximity sensor 26 detects a substantial change in signal I1, device 10 may be placed in close proximity mode 508-2. As described in connection with FIG. 3, device 10 may temporarily disable touch screen functionality in display 14 and/or may disable display 14 when operated in close proximity mode 508-2. In general, a “substantial change” may be considered any amount of detectable change in I1 depending on the resolution of the near-field sensor. For example, the transition to mode 508-2 may be taken in response to detecting a 10% change in the baseline amount of I1 recorded during state 506, a 20% change, a 50% change or more, etc.

Device 10 may continue operating in mode 508-2 until the cumulative intensity reading (i.e., the sum of I1 and I2) falls below a predetermined intensity threshold value Ithreshold. Alternative, only signal I1 may be monitored. As yet another embodiment, distance information d1 and/or d2 may be analyzed. In response to the cumulative intensity reading falling below value Ithreshold, device 10 may return to normal mode 500, as indicated by path 512.

The foregoing is merely illustrative of the principles of this invention and various modifications can be made by those skilled in the art without departing from the scope and spirit of the invention. The foregoing embodiments may be implemented individually or in any combination.

What is claimed is:

1. An electronic device, comprising:
a proximity sensor that provides near-field measurement results and far-field measurement results;
processing circuitry that receives the near-field measurement results and the far-field measurement results from the proximity sensor; and
a display, wherein the processing circuitry selectively enables and disables the display based on the received near-field measurement results and the far-field measurement results.

2. The electronic device defined in claim 1, wherein the proximity sensor outputs time-of-flight information.

3. The electronic device defined in claim 1, wherein the proximity sensor outputs a first distance value for the near-field measurement results and a second distance value for the far-field measurement results.

4. The electronic device defined in claim 3, wherein the proximity sensor further outputs a first intensity value for the near-field measurement results and a second intensity value for the far-field measurement results.

5. The electronic device defined in claim 1, wherein the proximity sensor includes circuitry for grouping the near-field measurement results and the far-field measurement results into separate bins.

6. The electronic device defined in claim 1, wherein the processing circuitry is configured to filter out the near-field measurement results.

7. The electronic device defined in claim 1, wherein the processing circuitry monitors the near-field measurement results to determine when dark objects make physical contact with the display.

8. The electronic device defined in claim 1, wherein the processing circuitry monitors the near-field measurement results to determine when smudge is deposited on the display.

9. The electronic device defined in claim 1, wherein the processing circuitry disables the display in response to detecting sudden changes in the far-field measurement results.

10. The electronic device defined in claim 1, wherein the near-field measurement results capture information relating to objects within a predetermined distance from an external surface of the display, and wherein the far-field measurement results capture information relating to objects beyond the predetermined distance from the external surface of the display.

11. A method for operating an electronic device, comprising:
emitting light from a proximity sensor;
receiving light at the proximity sensor;
outputting near-field data based on the received light at the proximity sensor; and
outputting far-field data based on the received light at the proximity sensor.

12. The method defined in claim 11, wherein outputting the far-field data comprises outputting measurement results for objects detected only beyond a predetermined distance from an external surface of the electronic device.

13. The method defined in claim 12, wherein outputting the near-field data comprises outputting measurement results for objects detected only within the predetermined distance from the external surface of the electronic device.

14. The method defined in claim 12, wherein outputting the near-field data comprises outputting measurement results for contaminants deposited on the external surface of the electronic device.

15. The method defined in claim 12, wherein the electronic device has a touch screen display that is enabled during normal mode, the method further comprising:
in response to detecting that the measurement results satisfy a trigger condition, configuring the electronic device in a close proximity mode by disabling the touch screen display.

16. The method defined in claim 15, further comprising:
while the electronic device is operating in the close proximity mode, reconfiguring the electronic device in the normal mode by enabling the touch screen display in response to detecting that the measurement results satisfy a release condition.

17. The method defined in claim 16, wherein the trigger and release conditions are different and provide hysteresis.

18. The method defined in claim 11, further comprising:
filtering out the near-field data.

19. The method defined in claim 11, further comprising:
monitoring for changes in the near-field data that exceed a predetermined threshold.

20. A sensor, comprising:
an emitter that emits light;
a detector that receives corresponding reflected light;
a first output on which only near-field information is provided; and
a second output on which only far-field information is provided.

21. The sensor defined in claim 20, wherein the near-field and far-field information contains time-of-flight information.
